(19) United States
(12) Patent Application Publication
(10) Pub. No.: US 2009/0284094 A1
(43) Pub. Date: Nov. 19, 2009

(54) Rotor Structure for Motor

(76) Inventors: Alex Horng, Kaohsiung (TW); Tso-Kuo Yin, Kaohsiung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/145,603

(22) Filed: Jun. 25, 2008

(30) Foreign Application Priority Data
May 15, 2008 (TW) 97117819

(51) Int. Cl. H02K 1/27

(52) U.S. Cl. 310/156.22; 310/156.21

(57) ABSTRACT

A rotor structure for motor includes a shaft, a magnet, and two fixing seats. The shaft passes through the magnet and the two fixing seats, with the two fixing seats being adjacent to and abuts against two end faces of the magnet respectively. The magnet slightly closely fits or loosely fits the shaft, and the two fixing seats closely fit the shaft, such that the magnet is positioned at a predetermined position relative to the shaft without rupture. Furthermore, the two end faces and two abutting faces by each of which the fixing seat abuts against one of the end faces are formed with rough surfaces or corresponding grooves and protrusions, so as to achieve stable-engaging effect between the magnet and fixing seats.

### BACKGROUND OF THE INVENTION

1. Field of the Invention

The present invention relates to a rotor structure for motor and, more particularly, to a rotor structure for providing a stable linkage between a shaft and a magnet and preventing the magnet from rupture.

2. Description of the Related Art

As shown in FIG. 1, a conventional rotor structure for brushless motor includes a shaft 10 and a magnet 20. The magnet 20 is in a shape of a cylinder with an axial hole 21 extending through the magnet 20 along a centerline of the cylinder for the shaft 10 to pass through said axial hole 21. Conventionally, there are two ways to provide a linkage between the shaft 10 and magnet 20, which are linkages realized through “close-fit design” and “adhesive” and are discussed in detail as the following.

The linkage between the shaft 10 and magnet 20 provided by “close-fit design” is achieved by arranging the axial hole 21 of the magnet 20 closely fitting the shaft 10, such that the magnet 20 is coupled with the shaft 10 and able to synchronously revolve therewith. However, owing to the fragility of the magnet 20, coupling the shaft 10 and magnet 20 by “close-fit design” leads the magnet 20 to rupture easily. Moreover, if the magnet 20 dose not fit the shaft 10 close enough, the shaft 10 may be disengaged from the magnet 20 because of the temperature-induced expansion and contraction. And the disengagement between the shaft 10 and magnet 20 will further cause the magnet 20 being unable to synchronously revolve with the shaft 10.

Said the other way, that is, linking the shaft 10 and magnet 20 through “adhesive” is achieved by applying adhesive between the shaft 10 and the axial hole 21 of the magnet 20, such that the magnet 20 is coupled with the shaft 10 and able to synchronously revolve therewith. However, lifetime of the applied adhesive is limited, which will not be able to provide stickiness when the lifetime thereof is end. Besides, because the rotor structure is ordinarily operated under high temperature and high rotational speed, the lifetime of said adhesive is easily shortened.

Accordingly, there is a need for redesigning the conventional rotor structure.

### SUMMARY OF THE INVENTION

The primary objective of this invention is to provide a rotor structure for motor having two fixing seats jointly positioning a magnet at a predetermined position relative to a shaft, with an axial hole of the magnet slightly closely fitting or loosely fitting the shaft and the fixing seats closely fitting said shaft. Accordingly, the magnet is prevented from rupture or being unable to synchronously revolve with the shaft owing to disengagement between the shaft and magnet.

The secondary objective of this invention is to provide the rotor structure for motor with two end faces of the magnet and two abutting faces of said fixing seats being formed with rough surfaces or corresponding grooves and protrusions, so as to achieve stable-engaging effect between the magnet and fixing seats.

The rotor structure for motor in accordance with an aspect of the present invention includes a shaft, a magnet and two fixing seats. The magnet has two opposite end faces, with an axial hole extending between said two end faces. The two fixing seats each has an abutting face, with a positioning hole disposed at the center of the abutting face. The shaft passes through the axial hole of the magnet and the positioning holes of the fixing seats. The two fixing seats are adjacent to and abut against the end faces of the magnet by the abutting faces respectively to position the magnet at a predetermined position relative to the shaft. Furthermore, the axial hole of the magnet slightly closely fits or loosely fits the shaft while the positioning holes of the fixing seats closely fits the shaft.

In a separate aspect of the present invention, the end faces of the magnet and the abutting faces of the fixing seats are formed with rough surfaces, correspondingly provide at least one pair of first and second engaging members, or have the rough surfaces and said engaging members both.

Further scope of the applicability of the present invention will become apparent from the detailed description given hereinafter in connection with drawings. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinafter, and the accompanying drawings that are given by way of illustration only are not limitations of the present invention, wherein:

FIG. 1 is a cross-sectional side view illustrating a conventional rotor structure for motor;

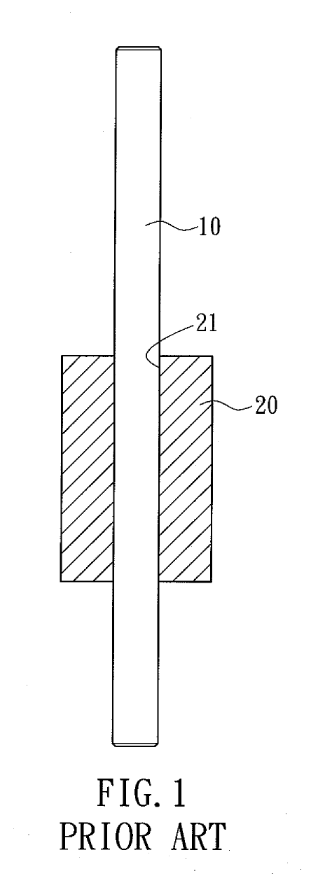

FIG. 2 is an exploded perspective view illustrating a rotor structure for motor in accordance with a first embodiment of the present invention;

FIG. 3 is a cross-sectional side view illustrating the rotor structure for motor in accordance with the first embodiment of the present invention;

FIG. 4 is an exploded perspective view illustrating a rotor structure for motor in accordance with a configuration of a second embodiment of the present invention;

FIG. 5 is a cross-sectional side view illustrating the rotor structure for motor in accordance with the configuration of the second embodiment of the present invention;

FIG. 6 is an exploded perspective view illustrating a rotor structure for motor in accordance with another configuration of the second embodiment of the present invention;

FIG. 7 is an exploded perspective view illustrating a rotor structure for motor in accordance with a third embodiment of the present invention;

FIG. 8 is a cross-sectional side view illustrating the rotor structure for motor in accordance with the third embodiment of the present invention;

FIG. 9 is an exploded perspective view illustrating a rotor structure for motor in accordance with a fourth embodiment of the present invention; and

FIG. 10 is a cross-sectional side view illustrating the rotor structure for motor in accordance with the fourth embodiment of the present invention.

In the various figures of the drawings, the same numerals designate the same or similar parts. Furthermore, when the terms “first”, “second” and similar terms are used hereinafter, it should be understood that these terms are reference only to the structure shown in the drawings as it would appear to a person viewing the drawings and are utilized only to facilitate describing the invention.

### DETAILED DESCRIPTION OF THE INVENTION

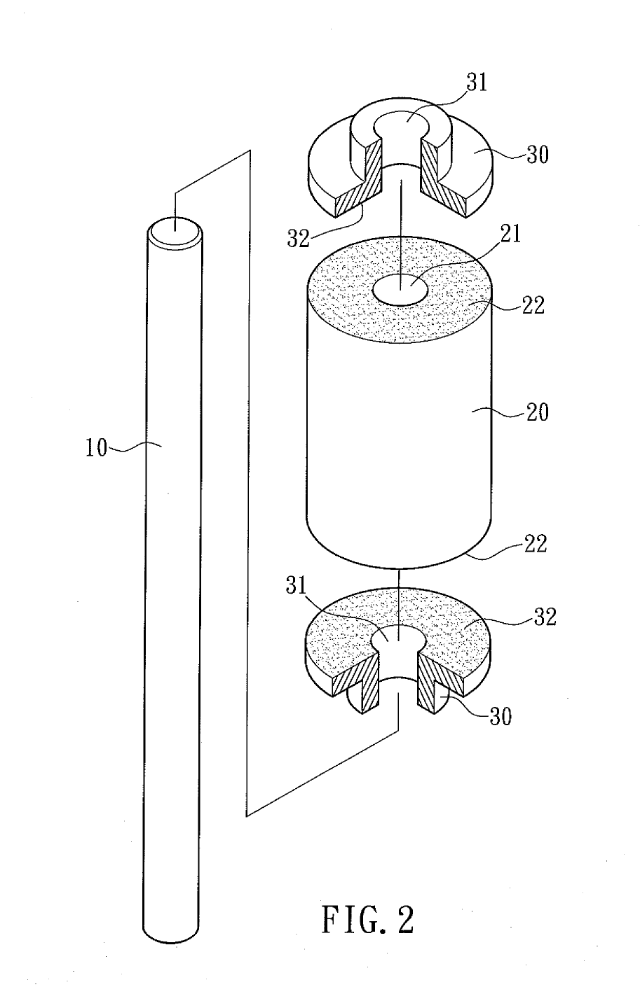

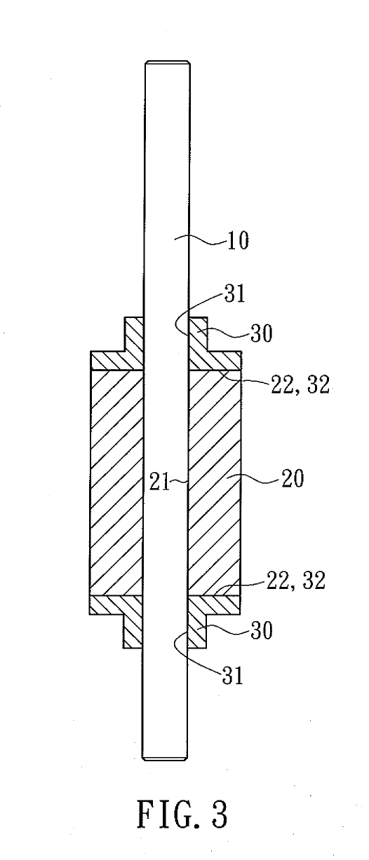

Referring now to FIGS. 2 and 3, a rotor structure for motor in accordance with a first embodiment is illustrated. The rotor structure includes a shaft 10, a magnet 20, and two fixing seats 30. The shaft 10 is in a shape of a cylindrical stick. The magnet 20 is in a shape of cylinder and has an axial hole 21 and two opposite end faces 22, with the axial hole 21 extending between centers of said two end faces 22 and each of the end faces 22 being formed with a rough surface. Each fixing seat 30 has an abutting face 32 also formed with a rough surface and a positioning hole 31 disposed at the center of the abutting face 32.

In assembly, the shaft 10 passes through the axial hole 21 of the magnet 20 and the positioning holes 31 of the fixing seats 30, with the two fixing seats 30 being adjacent to and abutting against the end faces 22 of the magnet 20 by the abutting faces 32 respectively. Furthermore, the axial hole 21 of the magnet 20 slightly closely fits or loosely fits the shaft 10, and both the positioning holes 31 of the fixing seats 30 closely fit said shaft 10. The two fixing seats 30 can thereby jointly position the magnet 20 at a predetermined position relative to the shaft 10. Besides, great friction between the abutting faces 32 of the fixing seats 30 and the end faces 22 of the magnet 20 is provided through the rough surfaces thereof. As a result, a stable linkage between the shaft 10 and the magnet 20 is achieved, and the magnet 20 is therefore able to synchronously revolve with the shaft 10.

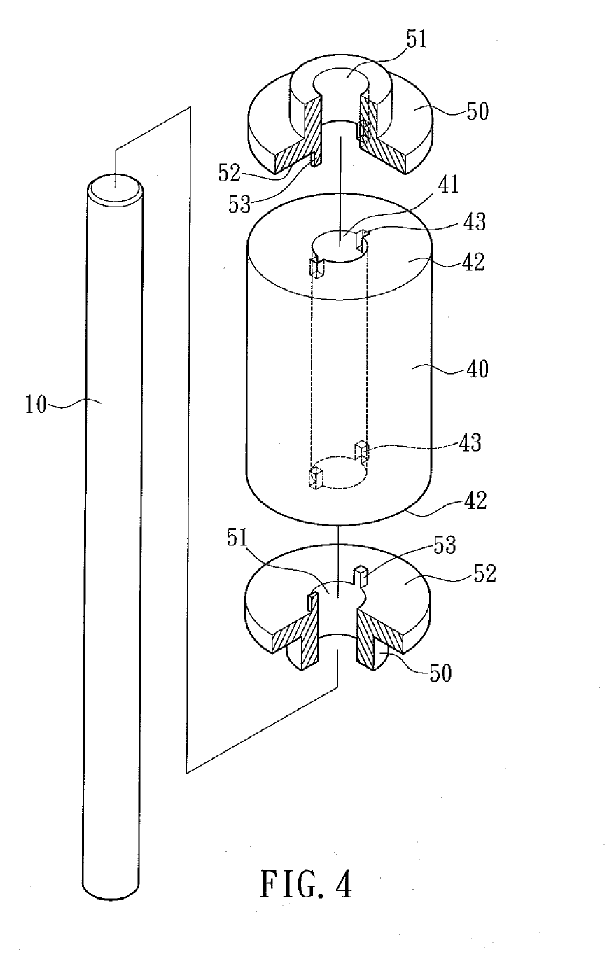

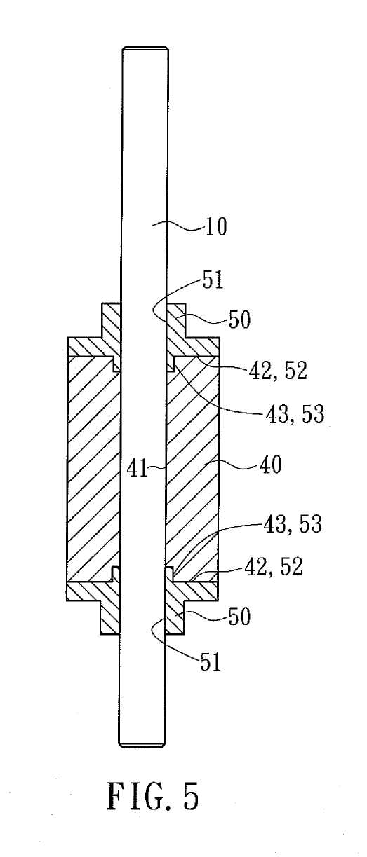

Referring now to FIGS. 4 and 5, a rotor structure for motor in accordance with a configuration of a second embodiment is illustrated. The rotor structure also includes the shaft 10, a magnet 40, and two fixing seats 50. The magnet 40 has an axial hole 41 and two opposite end faces 42, with the axial hole 41 extending between said two end faces 42. And each fixing seat 50 has an abutting face 52 and a positioning hole 51 disposed at the center of the abutting face 52. In assembly, the shaft 10 passes through the axial hole 41 of the magnet 40 and the positioning holes 51 of the fixing seats 50, with the two fixing seats 50 being adjacent to and abutting against the end faces 42 of the magnet 40 by the abutting faces 52 respectively for jointly positioning the magnet 40 at a predetermined position relative to the shaft 10. Furthermore, the axial hole 41 of the magnet 40 slightly closely fits or loosely fits the shaft 10, and both the positioning holes 51 of the fixing seats 50 closely fit said shaft 10. What is different from the rotor structure of the first embodiment is that each of the end faces 42 has at least one first engaging member 43 while each of the abutting faces 52 has at least one second engaging member 53 facing and engaging with said at least one first engaging member 43. The at least one first engaging member 43 is preferably selected from at least one groove or protrusion with the at least one second engaging member 53 being correspondingly selected from at least one protrusion or groove. Besides, amounts of the at least one first engaging member 43 and second engaging member 53 for the end faces 42 and the abutting faces 52 abutting against each other are corresponding to each other.

In FIGS. 4 and 5 showing said configuration of the second embodiment, the amount of the at least one first engaging member 43 is two for each end face 42 of the magnet 40, with said two first engaging members 43 being disposed at an inner edge of each end face 42 and adjacent to the axial hole 41. And the amount of the at least one second engaging members 53 is also two and correspondingly disposed on the abutting face 52 of each fixing seat 50. Moreover, for said configuration, at least one groove is selected as the at least one first engaging member 43 therein while at least one protrusion is selected as the at least one second engaging member 53.

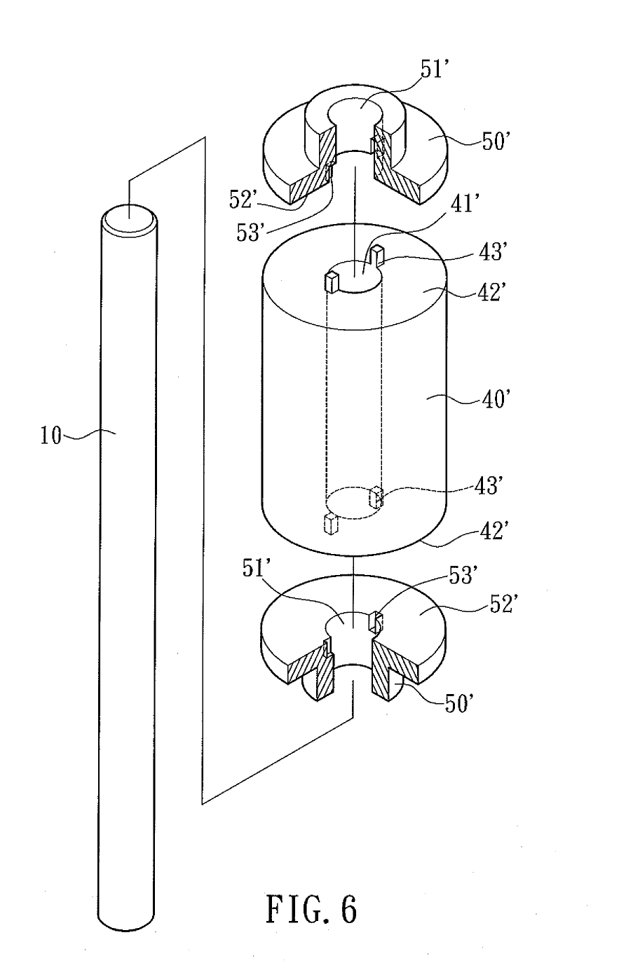

Referring now to FIG. 6, a rotor structure for motor in accordance with another configuration of the second embodiment is illustrated. Over the rotor structure of the configuration, structures of the shaft 10, a magnet 40′ having an axial hole 41′ and two end faces 42′ with at least one first engaging member 43′, and two fixing seats 50′ each having a positioning hole 51′ and an abutting face 52′ with at least one second engaging member 53′ are similar to that of the second embodiment. And the amounts of the at least one first and second engaging members 43′, 53′ for each end face 42′ and abutting face 52′ are two as shown. In FIG. 6 showing said another configuration of the second embodiment, although the two engaging members 43′ are also disposed at an inner edge of each end face 42′ adjacent to the axial hole 41′ with the two second engaging members 53′ facing and engaging therewith, two protrusions are selected as the two engaging members 43 while two grooves are selected as the two second engaging members 53.

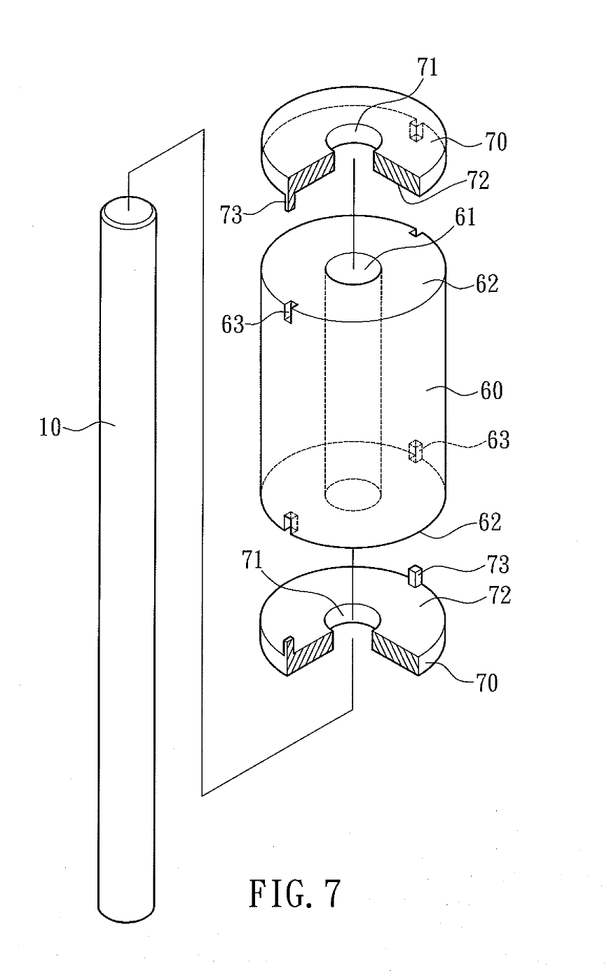

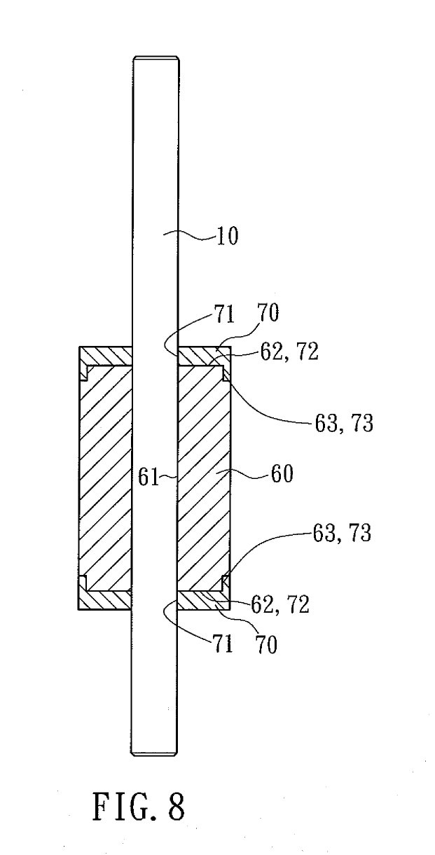

Referring now to FIGS. 7 and 8, a rotor structure for motor in accordance with a third embodiment is illustrated. Over the rotor structure of the third embodiment, configurations of the shaft 10, a magnet 60 having an axial hole 61 and two end faces 62 with at least one first engaging member 63, and two fixing seats 70 each having a positioning hole 71 and an abutting face 72 with at least one second engaging member 73 are similar to that of the second embodiment. Although, in FIGS. 7 and 8, the amount of the at least one first engaging member 63 is also two for each end face 62 of the magnet 60, said two first engaging members 63 are disposed at an outer edge of each end face 62. And the amount of the at least one second engaging members 73 is also two and correspondingly disposed on the abutting face 72 of each fixing seat 70. Moreover, instead of the fixing seats 30, 50, 50′ each having a sleeve around the positioning holes 31, 51 or 51′ on surfaces opposite to the abutting faces 32, 52 or 52′, the fixing seats 70 are in a shape of simple flat plate or block.

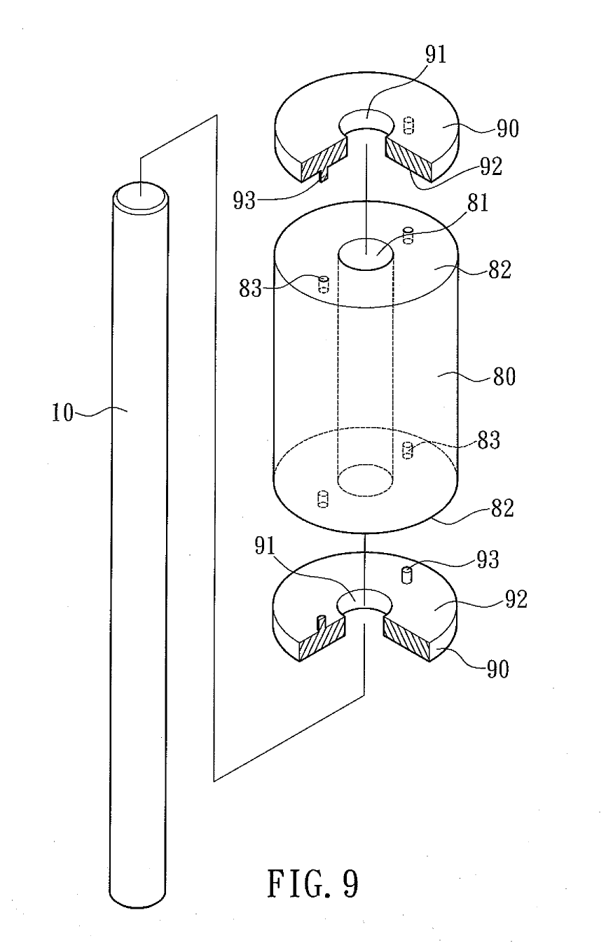

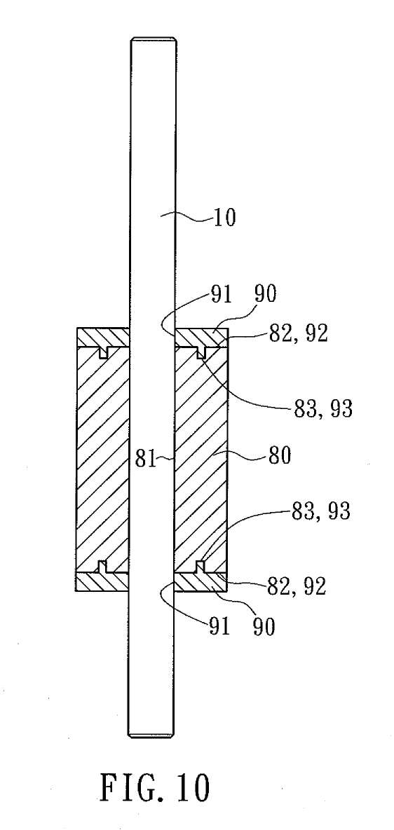

Referring now to FIGS. 9 and 10, a rotor structure for motor in accordance with a fourth embodiment is illustrated. Over the rotor structure of the fourth embodiment, configurations of the shaft 10, a magnet 80 having an axial hole 81 and two end faces 82 with at least one first engaging member 83, and two fixing seats 90 each having a positioning hole 91 and an abutting face 92 with at least one second engaging member 93 are also similar to that of the second embodiment. Although, in FIGS. 9 and 10, the amount of the at least one first engaging member 83 is also two for each end face 82 of the magnet 80, said two first engaging members 83 are disposed on the end face 82 between inner and outer edges thereof.

Instead of the end faces 22 and abutting face 32 formed with rough surfaces of the first embodiment, the first engaging members 43, 43′, 63, 83 and the second engaging members 53, 53′, 73, 93 of the other embodiments can also provide a stable linkage between the shaft 10 and any of the magnets 40, 40′, 60, 80, and the magnets 40, 40′, 60, 80 are therefore able to synchronously revolve with the shaft 10. Moreover, in order to provide a further stable-engaging effect between the magnets 20, 40, 40′, 60, 80 and fixing seats 30, 50, 50′, 70, 90, the end faces 22, 42, 42′, 62, 82 and the abutting faces 32, 52, 52′, 72, 92 can not only provide at least one pair of the first engaging members 43, 43′ 63, 83 and the second engaging members 53, 53′, 73, 93 but also be formed with the rough surfaces.

In comparison with the conventional rotor structure, the present invention can obviously provides two improvements as the following. Firstly, because the axial holes 21, 41, 41′, 61, 81 of the magnets 20, 40, 40′, 60, 80 slightly closely fit or loosely fit the shafts 10 while the positioning holes 31, 51, 51′, 71, 91 of the fixing seats 30, 50, 50′, 70, 90 closely fit said shafts 10, the fixing seats 30, 50, 50′, 70, 90 can thereby position each of the magnets 20, 40, 40′, 60, 80 at a predetermined position relative to each shaft 10. And therefore rupture of magnet caused by “close-fit design” of the shaft 10 and magnet 20 and disengagement between the shaft 10 and magnet 20 are avoided. Secondly, the end faces 22, 42, 42′, 62, 82 of the magnet 20, 40, 40′, 60, 80 and the abutting faces 32, 52, 52′, 72, 92 of the fixing seats 30, 50, 50′, 70, 90 can be formed with rough surfaces, correspondingly provide at least one pair of first engaging members 43, 43′, 63, 83 and second engaging members 53, 53′, 73, 93, or have the rough surfaces and said engaging members 43, 43′ 63, 83, 53, 53′ 73, 93 both, so as to achieve stable-engaging effect between the magnets 20, 40, 40′, 60, 80 and fixing seats 30, 50, 50′, 70, 90.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A rotor structure for motor, comprising:
a shaft;
a magnet having two opposite end faces, with an axial hole extending between said two end faces; and
two fixing seats each having an abutting face, with a positioning hole disposed at the center of the abutting face,
wherein the shaft passes through the axial hole of the magnet and the positioning holes of the fixing seats, the two fixing seats are adjacent to and abut against the end faces of the magnet by the abutting faces respectively to position the magnet relatively to the shaft, and both the positioning holes of the fixing seats closely fit said shaft.

2. The rotor structure for motor as defined in claim 1, wherein the two end faces of the magnet are formed with rough surfaces.

3. The rotor structure for motor as defined in claim 1, wherein the abutting face of the fixing seat is formed with a rough surface.

4. The rotor structure for motor as defined in claim 1, wherein the axial hole of the magnet slightly closely fits the shaft.

5. The rotor structure for motor as defined in claim 1, wherein the axial hole of the magnet loosely fits the shaft.

6. The rotor structure for motor as defined in claim 1, wherein at least one of the end faces has at least one first engaging member while at least one of the abutting faces facing said at least one of the end faces has at least one second engaging member facing and engaging with said at least one first engaging member.

7. The rotor structure for motor as defined in claim 6, wherein the at least one first engaging member is at least one groove and the at least one second engaging member is at least one protrusion.

8. The rotor structure for motor as defined in claim 6, wherein the at least one first engaging member is at least one protrusion and the at least one second engaging member is at least one groove.

9. The rotor structure for motor as defined in claim 6, wherein the at least one first engaging member is disposed at an inner edge of the end face and adjacent to the axial hole.

10. The rotor structure for motor as defined in claim 6, wherein the at least one first engaging member is disposed at an outer edge of the end face.

11. The rotor structure for motor as defined in claim 6, wherein the at least one first engaging member is disposed between inner and outer edges of the end face.
